(19) United States
(12) Patent Application Publication
(10) Pub. No.: US 2014/0365724 A1
(43) Pub. Date: Dec. 11, 2014

(54) SYSTEM AND METHOD FOR CONVERTING DISK PARTITION FORMAT

(71) Applicants: HON HAI PRECISION INDUSTRY CO., LTD., New Taipei (TW); HONG FU JIN PRECISION INDUSTRY (WuHan) CO., LTD., Wuhan (CN)

(72) Inventors: ZHI-BING ZHOU, Wuhan (CN); LU LIU, Wuhan (CN); XIN-CHENG AI, Wuhan (CN); TAN-CHIANG WANG, New Taipei (TW)

(73) Assignees: HON HAI PRECISION INDUSTRY CO., LTD., New Taipei (TW); HONG FU JIN PRECISION INDUSTRY (WUHAN) CO., LTD., Wuhan (CN)

(21) Appl. No.: 14/223,979

(22) Filed: Mar. 24, 2014

(30) Foreign Application Priority Data
Jun. 6, 2013 (CN) 201310222967X

(51) Int. Cl. G06F 12/02

(52) U.S. Cl. CPC G06F 12/023; G06F 2212/70; G06F 2212/211
USPC 711/112

(57) ABSTRACT

An electronic device includes a hard disk drive for data storage. One or more programs are executed to cause the electronic device to perform a disk partition format conversion procedure. The procedure includes reading a first disk partition table (DPT) from the HDD of a first disk partition format, converting the first DPT into a second DPT in compliance with a second disk partition format, converting the HDD of the first disk partition format into the second disk partition format, and writing the second DPT to the HDD of the second disk partition format.

### REFERENCE TO RELATED APPLICATIONS

This application claims all benefits accruing under 35 U.S.C. §119 from China Patent Application No. 201310222967.X, filed on Jun. 6, 2013 in the State Intellectual Property Office of China, entire contents of which are hereby incorporated by reference.

### BACKGROUND

1. Technical Field

The disclosure generally relates to storage devices, and particularly relates to systems and methods for converting a hard disk drive (HDD) of a first disk partition format into a second disk partition format.

2. Description of Related Art

Most computers store data in hard disk drives (HDDs). Generally, an HDD is divided into multiple logic storage units referred to as partitions. There are two major disk partition formats: the master boot record (MBR) format and the globally unique identifier partition table (GPT) format. However, converting the HDD of one partition format into another partition format often results in data loss.

Therefore, there is room for improvement within the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the views.

FIG. 1 is a block diagram of an embodiment of an electronic device.

FIG. 2 is a schematic view of a hard disk drive (HDD) of the master boot record (MBR) format.

FIG. 3 is a schematic view of an HDD of the globally unique identifier partition table (GPT) format.

FIG. 4 is a block diagram of an embodiment of a disk partition format conversion system.

FIG. 5 is a flowchart of an embodiment of a disk partition format conversion method.

### DETAILED DESCRIPTION

The disclosure is illustrated by way of example and not by way of limitation in the figures of the accompanying drawings, in which like reference numerals indicate similar elements. It should be noted that references to “an” or “one” embodiment in this disclosure are not necessarily to the same embodiment, and such references can mean “at least one.”

In general, the word “module,” as used herein, refers to logic embodied in hardware or firmware, or to a collection of software instructions, written in a programming language such as Java, C, or assembly. One or more software instructions in the modules may be embedded in firmware, such as in an erasable-programmable read-only memory (EPROM). The modules described herein may be implemented as either software and/or hardware modules and may be stored in any type of non-transitory computer-readable medium or other storage device. Some non-limiting examples of non-transitory computer-readable media are compact discs (CDs), digital versatile discs (DVDs), Blu-Ray discs, Flash memory, and hard disk drives.

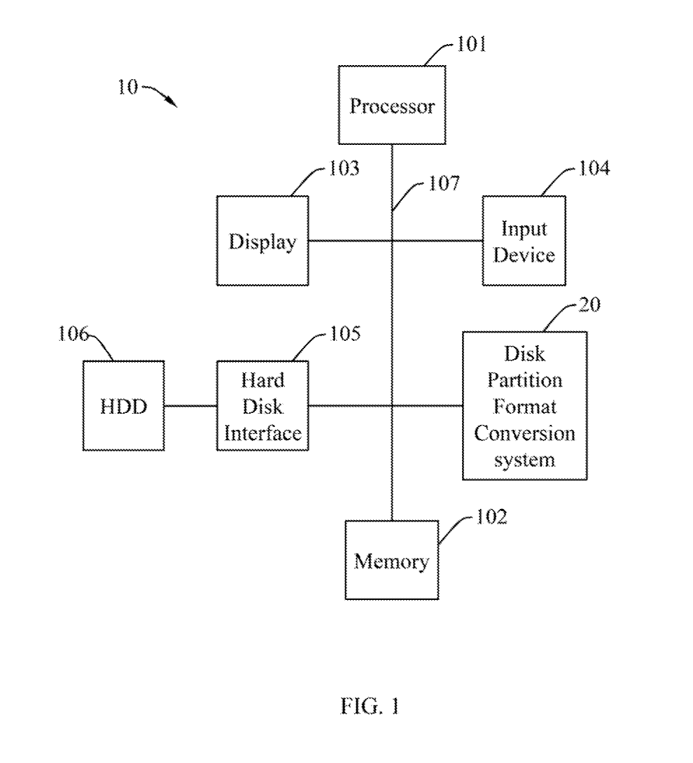

FIG. 1 is a block diagram of an embodiment of an electronic device 10 suitable for implementing a disk partition format conversion system 20. The electronic device 10 can be, but is not limited to, a personal computer, a workstation computer, a server computer, a gaming device, a hard disk copy machine, a television set, a personal digital assistant (PDA), a smart phone, or any other type of portable or non-portable electronic device.

In the illustrated embodiment of FIG. 1, the electronic device 10 includes at least one processor 101, a suitable amount of memory 102, a display 103, at least one input device 104, a hard disk interface 105, and a hard disk drive (HDD) 106. Of course, the electronic device 10 may include additional elements, components, modules, and be functionality configured to support various features that are unrelated to the subject matter described here. In practice, the elements of the electronic device 10 may be coupled together via a bus or any suitable interconnection architecture 107.

The processor 101 may be implemented or performed with a general purpose processor, a content addressable memory, a digital signal processor, an application specific integrated circuit, a field programmable gate array, any suitable programmable logic device, discrete gate or transistor logic, discrete hardware components, or any combination designed to perform the functions described herein.

The memory 102 may be realized as RAM memory, flash memory, EPROM memory, EEPROM memory, registers, a hard disk, a removable disk, a CD-ROM, or any other form of storage medium known in the art. The memory 102 is coupled to the processor 101 such that the processor 101 can read information from, and write information to, the memory 102. The memory 102 can be used to store computer-executable instructions. The computer-executable instructions, when read and executed by the processor 101, cause the electronic device 10 to perform certain tasks, operations, functions, and processes described in more detail herein.

The display 103 is suitably configured to enable the electronic device 10 to render and display various screens, GUIs, GUI control elements, menus, texts, or images, for example. Of course, the display 103 may also be utilized for the display of other information during the operation of the electronic device 10, as is well understood.

The input device 104 provides an input interface between the electronic device 10 and a user. The input device 104 can be a mouse, a keyboard, a touchpad, a joystick, or any other suitable type of input device.

The hard disk interface 105 may provide connectivity channels for reading/writing data from/to the HDD 106. The hard disk interface 105 may represent a serial advanced technology attachment (SATA) controller or a small computer system interface (SCSI), for example.

The disk partition format conversion system 20 may be implemented in the electronic device 10 using software, firmware, or other computer programming technologies. In the embodiment, the disk partition format conversion system 20 may convert the HDD 106 of the master boot record (MBR) format into the globally unique identifier partition table (GPT) format, or vice versa.

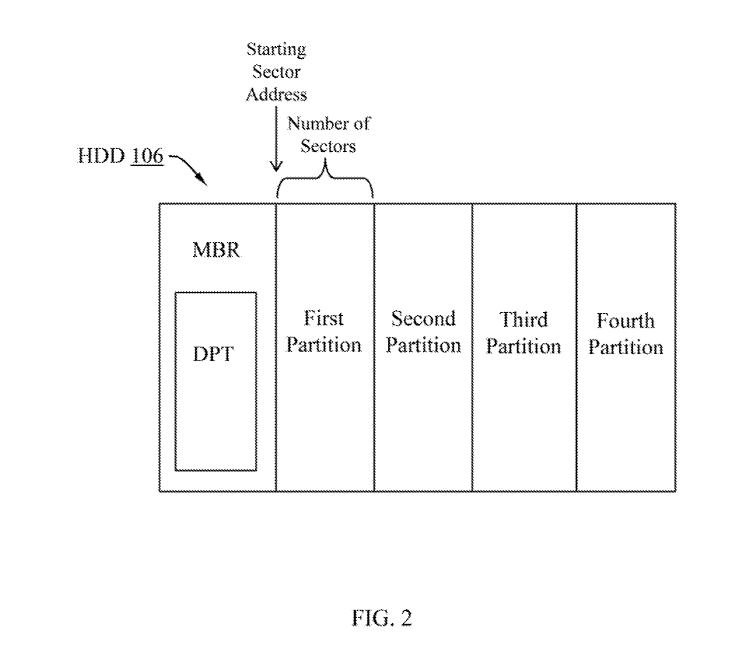

FIG. 2 shows a schematic view of the HDD 106 in the MBR format. When the HDD 106 is in the MBR format, an MBR is written in the HDD 106. The MBR includes a disk partition table (DPT), which records information of disk partitions. Each partition entry of the DPT stores information regarding a starting sector address pointing to a disk partition, and a total number of sectors of the disk partition. A sector is a subdivision of a track on a magnetic disk or optical disc, which stores a fixed amount of user-accessible data, traditionally 512 bytes for the hard disk.

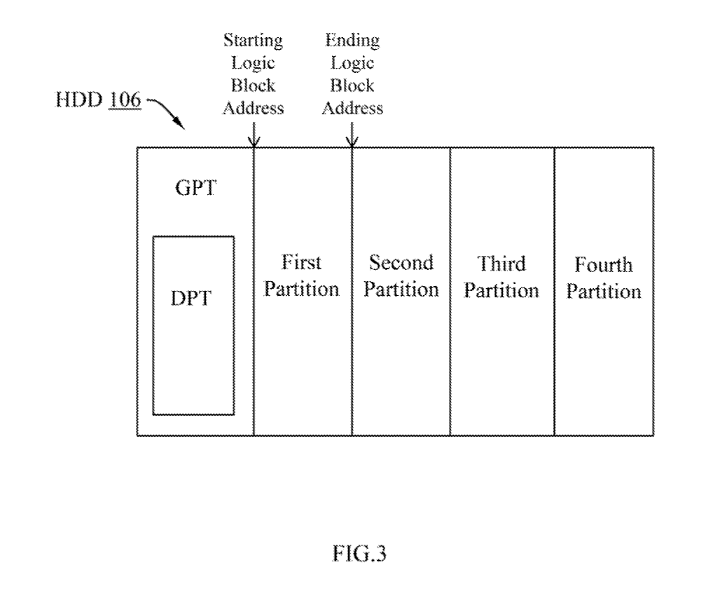

FIG. 3 shows a schematic view of the HDD 106 in the GPT format. When the HDD 106 is in the GPT format, a GPT is written in the HDD 106. The GPT includes a DPT, which records information of disk partitions. Each partition entry of the second DPT stores information regarding a starting logic block address and an ending logic block address pointing to a disk partition. The GPT format uses logical block addressing in place of the sector addressing of the MBR format. A logic block traditionally includes 2 sectors of the hard disk. However, a total number of sectors (also referred to as a length) of a logic block may be user-defined in different systems.

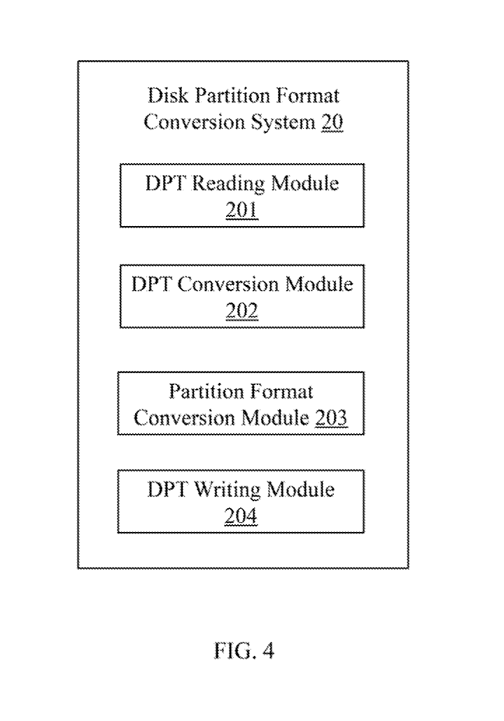

FIG. 4 shows a block diagram of an embodiment of the disk partition format conversion system 20 implemented in the electronic device 10. The disk partition format conversion system 20 includes a DPT reading module 201, a DPT conversion module 202, a partition format conversion module 203, and a DPT writing module 204.

The DPT reading module 201 reads a first DPT from the HDD 106 of a first disk partition format via the hard disk interface 105. The first DPT is in compliance with the first disk partition format. When the first disk partition format is the GPT format, the DPT reading module 201 further reads information regarding a total number of sectors of a logic block from a GPT header of the HDD 106.

The DPT conversion module 202 converts the first DPT into a second DPT in compliance with a second disk partition format.

When the first disk partition format is the MBR format and the second disk partition format is the GPT format, the DPT conversion module 202 obtains a starting logic block address and an ending logic block address pointing to a disk partition, according to the following equations:

$${A}_{1} = \frac{{S}_{1}}{L} , \\ {A}_{2} = \frac{{S}_{2}}{L} + {A}_{1} - 1 ,$$

Wherein A₁ represents the starting logic block address, A₂ represents the ending logic block address, S₁ represents a starting sector address pointing to the disk partition, S₂ represents a total number of sectors of the disk partition, and L represents a total number of sectors of a logic block.

When the first disk partition format is the GPT format and the second disk partition format is the MBR format, the DPT conversion module 202 obtains a starting sector address pointing to a disk partition and a total number of sectors of the disk partition, according to the following equations:

S₁=A₁*L,

S₂=(A₂−A₁±1)*L,

Wherein S₁ represents the starting sector address, S₂ presents the total number of sectors of the disk partition, A₁ represents a starting logic block address of the disk partition, A₂ represents an ending logic block address of the disk partition, and L represents a total number of sectors of a logic block.

The partition format conversion module 203 converts the HDD 106 of the first disk partition format into the second disk partition format. In some embodiments, the partition format conversion module 203 utilizes a known partition format conversion command line interface (CLI), such as “Diskpart,” to perform the partition format conversion.

When the partition format conversion module 203 has completed the partition format conversion, the DPT writing module 204 writes the second DPT into the HDD 106 via the hard disk interface 105. When the second partition format is the GPT format, the DPT writing module 202 further writes information regarding the total number of sectors of a logic block into the GPT header of the HDD 106.

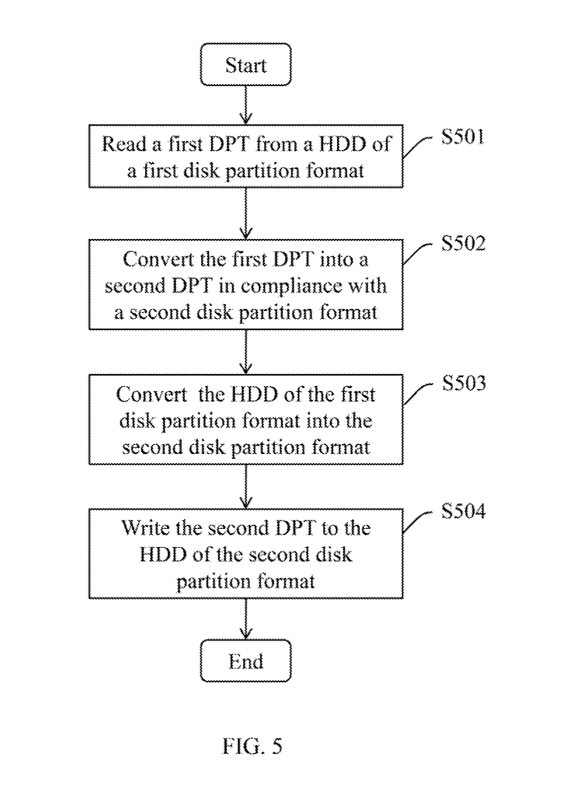

FIG. 5 shows a flowchart of one embodiment of a disk partition format conversion method. The method includes the following steps.

In step S501, the DPT reading module 201 reads a first DPT from the HDD 106 of a first disk partition format via the hard disk interface 105. The first DPT is in compliance with the first disk partition format. When the first disk partition format is the GPT format, the DPT reading module 201 reads information regarding a total number of sectors of a logic block from a GPT header of the HDD 106.

In step S501, the DPT conversion module 202 converts the first DPT into a second DPT in compliance with a second disk partition format.

When the first disk partition format is the MBR format and the second disk partition format is the GPT format, the DPT conversion module 202 obtains a starting logic block address and an ending logic block address pointing to a disk partition, according to the following equations:

$${A}_{1} = \frac{{S}_{1}}{L} , \\ {A}_{2} = \frac{{S}_{2}}{L} + {A}_{1} - 1 ,$$

Where A₁ represents the starting logic block address, A₂ represents the ending logic block address, S₁ represents a starting sector address pointing to the disk partition, S₂ presents a total number of sectors of the disk partition, and L represents a total number of sectors of a logic block.

When the first disk partition format is the GPT format and the second disk partition format is the MBR format, the DPT conversion module 202 obtains a starting sector address pointing to a disk partition and a total number of sectors of the disk partition by using the following equations:

S₁=A₁*L,

S₂=(A₂−A₁±1)*L,

Where S₁ represents the starting sector address, S₂ presents the total number of sectors of the disk partition, A₁ represents a starting logic block address of the disk partition, A₂ represents an ending logic block address of the disk partition, and L represents a total number of sectors of a logic block.

In step S503, the partition format conversion module 203 converts the HDD 106 of the first disk partition format into the second disk partition format.

In step S504, the DPT writing module 204 writes the second DPT into the HDD 106 via the hard disk interface 105. When the second partition format is the GPT format, the DPT writing module 202 writes information regarding the total number of sectors of a logic block into the GPT header of the HDD 106.

Although numerous characteristics and advantages have been set forth in the foregoing description of embodiments, together with details of the structures and functions of the embodiments, the disclosure is illustrative only, and changes may be made in detail, especially in the matters of arrangement of parts within the principles of the disclosure to the full extent indicated by the broad general meaning of the terms in which the appended claims are expressed.

What is claimed is:

1. An electronic device, comprising:
a memory;
at least one processor coupled to the memory;
one or more programs being stored in the memory and executable by the at least one processor, the one or more programs comprising:
a disk partition table (DPT) reading module configured for reading a first disk partition table (DPT) from a hard disk drive (HDD) of a first disk partition format;
a DPT conversion module configured for converting the first DPT into a second DPT in compliance with a second disk partition format;
a partition format conversion module configured for converting the HDD of the first disk partition format into the second disk partition format; and
a DPT writing module configured for writing the second DPT to the HDD of the second disk partition format.

2. The electronic device of claim 1, wherein the first disk partition format is the master boot record (MBR) format, the second disk partition format is the globally unique identifier partition table (GPT) format, each partition entry of the first DPT stores information regarding a starting sector address pointing to a disk partition and a total number of sectors of the disk partition, each partition entry of the second DPT stores information regarding a starting logic block address and an ending logic block address pointing to a disk partition, the DPT conversion module is configured for obtaining the starting logic block address and the ending logic block address pointing to the disk partition by using the following equations:
$${A}_{1} = \frac{{S}_{1}}{L} , \\ {A}_{2} = \frac{{S}_{2}}{L} + {A}_{1} - 1 ,$$
Where A₁ represents the starting logic block address, A₂ represents the ending logic block address, S₁ represents the starting sector address, S₂ represents the total number of sectors of the disk partition, and L represents a total number of sectors of a logic block.

3. The electronic device of claim 2, wherein the DPT writing module is further configured for writing information regarding the total number of sectors of the defined logic block into a GPT header of the HDD of the second disk partition format.

4. The electronic device of claim 1, wherein the first disk partition format is the GPT format, the second disk partition format is the MBR format, the first DPT is in compliance with the GPT format, the second DPT is in compliance with the MBR format, each partition entry of the first DPT stores information regarding a starting logic block address and an ending logic block address pointing to a disk partition, each partition entry of the second DPT stores information regarding a starting sector address pointing to a disk partition and a total number of sectors of the disk partition, the DPT conversion module is configured for obtaining the starting sector address pointing to the disk partition and the total number of sectors of the disk partition by using the following equations:
S₁=A₁*L,
S₂=(A₂−A₁±1)*L,
Where S₁ represents the starting sector address, S₂ presents the total number of sectors of the disk partition, A₁ represents the starting logic block address, A₂ represents the ending logic block address, and L represents a total number of sectors of a logic block.

5. The electronic device of claim 4, wherein the DPT reading module is further configured for reading information regarding the total number of sectors of the defined logic block from a GPT header of the HDD of the first disk partition format.

6. A disk partition format conversion method implemented in an electronic device, the method comprising:
reading a first disk partition table (DPT) from a hard disk drive (HDD) of a first disk partition format;
converting the first DPT into a second DPT in compliance with a second disk partition format;
converting the HDD of the first disk partition format into the second disk partition format; and
writing the second DPT to the HDD of the second disk partition format.

7. The disk partition format conversion method of claim 6, wherein the first disk partition format is the master boot record (MBR) format, the second disk partition format is the globally unique identifier partition table (GPT) format, each partition entry of the first DPT stores information regarding a starting sector address pointing to a disk partition and a total number of sectors of the disk partition, each partition entry of the second DPT stores information regarding a starting logic block address and an ending logic block address pointing to a disk partition, the step of converting the first DPT into a second DPT comprises obtaining the starting logic block address and the ending logic block address pointing to the disk partition by using the following equations:
$${A}_{1} = \frac{{S}_{1}}{L} , \\ {A}_{2} = \frac{{S}_{2}}{L} + {A}_{1} - 1 ,$$
Where A₁ represents the starting logic block address, A₂ represents the ending logic block address, S₁ represents the starting sector address, S₂ represents the total number of sectors of the disk partition, and L represents a total number of sectors of a logic block.

8. The disk partition format conversion method of claim 7, further comprising writing information regarding the total number of sectors of the defined logic block into a GPT header of the HDD of the second disk partition format.

9. The disk partition format conversion method of claim 6, wherein the first disk partition format is the GPT format, the second disk partition format is the MBR format, the first DPT is in compliance with the GPT format, the second DPT is in compliance with the MBR format, each partition entry of the first DPT stores information regarding a starting logic block address and an ending logic block address pointing to a disk partition, each partition entry of the second DPT stores information regarding a starting sector address pointing to a disk partition and a total number of sectors of the disk partition, the step of converting the first DPT into a second DPT comprises obtaining the starting sector address pointing to the disk partition and the total number of sectors of the disk partition by using the following equations:
S₁=A₁*L,
S₂=(A₂−A₁±1)*L,
Where S₁ represents the starting sector address, S₂ presents the total number of sectors of the disk partition, A₁ represents the starting logic block address, A₂ represents the ending logic block address, and L represents a total number of sectors of a logic block.

10. The disk partition format conversion method of claim 9, further comprising reading information regarding the total number of sectors of the defined logic block from a GPT header of the HDD of the first disk partition format.
